(19) United States
(12) Patent Application Publication
(10) Pub. No.: US 2023/0198777 A1
(43) Pub. Date: Jun. 22, 2023

(54) AUTHENTICATING A PUBLIC KEY OF A FIRST PERSON

(71) Applicant: KONINKLIJKE PHILIPS N.V., EINDHOVEN (NL)

(72) Inventor: ADRIAAN JORIS H. LARMUSEAU, EINDHOVEN (NL)

(21) Appl. No.: 17/927,015

(22) PCT Filed: May 27, 2021
(86) PCT No.: PCT/EP2021/064273

§ 371 Date: Nov. 22, 2022

(30) Foreign Application Priority Data
May 28, 2020 (WO) PCT/CN2020/092765

(51) Int. Cl. H04L 9/32; H04L 9/30

(52) U.S. Cl. CPC H04L 9/3247; H04L 9/3218; H04L 9/30

(57) ABSTRACT

Some embodiments are directed to a cryptographic authentication system 100. An authentication device authenticates a public key to a verification device as belonging to a first person with a given degree of kinship to a second person, without however disclosing the identity of the first person. To this end, the cryptographic authentication device generates a cryptographic proof, e.g., a zero-knowledge proof such as a zk-SNARK, that is verifiable with respect to at least the public key. The cryptographic proof proves that first genomic data of the first person and second genomic data of the second person have the given degree of kinship, as computed by a kinship function on the first and second genomic data; and that there exists a digital signature on the first genomic data that verifies successfully with respect to a verification key trusted by the verifier.

### FIELD OF THE INVENTION

The invention relates to a cryptographic authentication system for authenticating a public key using genomics-based kinship. The invention also relates to a cryptographic authentication device, a cryptographic key generation device, and a cryptographic verification device for use in such a system. The invention further relates to a cryptographic authentication method, a cryptographic key generation method, and a cryptographic verification method corresponding to the respective devices. The invention also relates to a computer readable storage medium.

### BACKGROUND OF THE INVENTION

When storing and processing genomic data, e.g., genomic sequences of people, at least two important and interrelated data security issues arise.

A first issue is that genomic data is highly sensitive information. Genomic data of a person can provide a lot of personal information about that person, for example, colour of the hair or eyes. Some of this information can be very sensitive, for example, whether the person is likely to develop a particular disease. Moreover, genomic data is highly identifiable: given two partially overlapping pieces of genomic information, it is usually easy to determine whether or not they refer to the same person. For this reason, it is also very hard to anonymize genomic data while keeping at least some of its utility. A second, related issue is that storing and processing genomic information of a particular person does not just affect the privacy of that person, but also the privacy of their family members, as their genomic information is highly interlinked.

Accordingly, in the area of storing and processing genomic information, it is desirable to move towards privacy-preserving solutions that respect both the privacy of subjects that share their genomic information as well as their family members.

For example, it is desirable to obtain and deal with consent of a family member of an individual of whom genetic information is to be stored or processed. Such consent may be provided, for example, in the form of a digitally signed consent statement by the family member, indicating the given consent. The family member may use a cryptographic private key to digitally sign the consent statement, and the digital signature may be verified using the corresponding cryptographic public key.

### SUMMARY OF THE INVENTION

It would be desirable to have technical means for authenticating a public key, e.g., a public key for use in digitally signing a consent statement, as belonging to a person with a given degree of kinship to another person.

Such authentication may be performed, for example, by the two persons together physically visiting a hospital or notary; identifying themselves using their passports, and declaring that they are family members. The hospital or notary may then issue a statement that the first person is indeed a kin of the second person and is in possession of a given public key. The first person could then use this public key to sign consent statements.

The invention is defined by the independent claims. The dependent claims define advantageous embodiments.

The inventors realized that it would be beneficial if such an authentication of a digital key as belonging to a person with a given degree of kinship to another person, could instead be performed digitally. For example, it would be beneficial if no physical visit to a hospital or notary or the like would be needed. It would also be beneficial if privacy of such an authentication could be improved. For example, it would be beneficial if the authentication of the public key could take place without a third party (such as a hospital or notary) being involved, and in particular, without such a third party being able to link the public key to a particular person (e.g., through a password, or through genomic information). Similarly, it would be beneficial if the public key could be authenticated to a party without that party being able to link the public key to a particular person. For example, this would allow application of the authentication techniques in settings where the party being authenticated to can be practically anybody, e.g., in a blockchain context.

In order to address these and other problems, a cryptographic authentication system is proposed, as defined by the claims. Also, a cryptographic authentication device, a cryptographic key generation device, and a cryptographic verification device are proposed, as defined by the claims. Each of the devices has specific features contributing to the various advantages described herein.

An authentication may involve a cryptographic authentication device (the “authenticator” in short) authenticating the public key to a cryptographic verification device (the “verifier” in short). The authentication may be for proving that the public key belongs to a first person with a given degree of kinship to a second person. The authentication device may be operated by, or on behalf of, the first person. The verification device may be operated on behalf of a third person, e.g., a notary or auditor. The public key can then be used, e.g., to digitally sign a consent statement or other type of document or digital data.

The inventors envisaged that the authenticator may authenticate the public key of the first person with respect to the first person's genomic data. To this end, the authenticator may hold genomic data representing a genomic sequence of the first person. Throughout this specification, genomic data may be DNA data and genomic sequences may be DNA sequences, although for example RNA data and sequences are also possible. The genomic sequence may be certified by an external party trusted by the verifier (e.g., a hospital, a sequencing company, a certification authority, a notary, etc.), in the form of a digital signature on the first genomic data signed by this external party.

Interestingly, instead of having the authenticator provide the first genomic data and the digital signature to the verifier for comparing it to second genomic data representing a genomic sequence of the second person, the inventors envisaged to use a cryptographic primitive referred to herein as a cryptographic proof. Using the cryptographic proof, the authenticator may prove, with respect to second genomic data of the second person, that the first genomic data belongs to a person with a given degree of kinship to the second person. Verifying the proof may convince the verifier that indeed, the public key belongs to a person with the given degree of kinship. Interestingly however, the proof typically does not allow the verifier to derive the first genomic data.

Generally, a “cryptographic proof” may refer to a cryptographic protocol between a prover, in this case the authenticator, and a verifier. In this proof, the prover proves knowledge of a set of values, called the “witness”, satisfying a given statement. Such a proof is also known as a “proof of knowledge”. Typically, the proof satisfies the property of completeness, meaning a prover knowing correct values manages to convince a verifier. Typically, the proof also satisfies validity, meaning that if a prover convinces the verifier, he likely knows correct values. Specifically, the proofs used herein may be zero-knowledge proofs, in which case proof may leak little or no information on which particular set of values satisfying the statement were used. Thus, a zero-knowledge proof has the surprising property of allowing a prover to prove knowledge of values satisfying a certain property, e.g., the private key corresponding to a given public key, without revealing what those values are.

In various embodiments, the cryptographic proof may prove that the public key that is to be authenticated, indeed belongs to a person with the given degree of kinship to the second person, by proving a combination of several statements.

One statement that may be proven, is that the first genomic data and the second genomic data have the given degree of kinship, as computed by a kinship function on the first and second genomic data. Thus, the witness of the cryptographic proof may comprise the first genomic data. The verifier may verify this statement with respect to the second genomic data or a representation of it (several examples of which are provided). This way, the cryptographic proof may establish a connection between the first genomic data, which is known to the authenticator but not to the verifier, and the second genomic data, of which a representation is known to the verifier.

Another statement that may be proven, is that the digital signature on the first genomic data, which is known to the authenticator, indeed verifies successfully with respect to the first genomic data and the verification key. Accordingly, for this statement, the witness may comprise the digital signature and the first genomic data. This way, the cryptographic proof may establish a connection between the first genomic data and the verification key, indicating that the party corresponding to the verification key (e.g., a third party trusted by the verifier) has certified the first genomic data. Accordingly, the verification key may be regarded as the source of trust in the authentication.

Preferably, the verifier verifies this statement with respect to the verification key, in other words, the verifier inputs the verification key to the verification procedure. This is not necessary however: for example, the verification key can also be hardcoded into the statement that the authenticator is configured to prove (e.g., it may be hardcoded into key material generated by a cryptographic key generation device). The verifier inputting the verification key provides more flexibility though.

Another statement that may be proven, is that the private key corresponding to the public key is input to the cryptographic proof. For this statement, the witness may comprise the private key. The verifier may verify this statement with respect to the public key to be authenticated. Accordingly, the cryptographic proof may be linked to the public key that is to be authenticated. In particular, if knowledge of the private key is proven, this may prevent a potential attack in which an attacker would take a cryptographic proof authenticating a public key, and manipulate this proof into a proof authenticating a different public key.

It is not necessary to prove that the private key is input to the cryptographic proof, however. It is also possible to link the public key to the cryptographic proof, for example, by using a so-called “signature of knowledge” proving that a person in possession of the witness (e.g., the first genomic data and the signature on it) has signed the public key. For example, signatures of knowledge are defined in M. Chase et al., “On Signatures of Knowledge” (available at https://eprintiacr.org/2006/184 and incorporated herein by reference). In any case, the verifier typically verifies the cryptographic proof with respect to the public key.

Accordingly, by linking the first genomic data of the first person, the second genomic data of the second person, the public key, the verification key, and the digital signature on the first genomic data (verifiable with respect to the verification key), the authenticator may prove to the verifier that the public key belongs to a first person with a given degree of kinship to the second person; or at least, to a party having access to the genomic data of that first person. In order to be convinced of this, the verifier may just need to trust the verification key, in other words, trust that genomic data that verifies successfully with respect to the verification key, is correct. The proof then provides a guarantee that the first genomic data does indeed verify successfully, and has the given degree of kinship with the second genomic data.

Interestingly, the provided techniques may allow to authenticate a public key fully digitally. Effectively, trust in the public key can be derived from the fact that a digital signature on the first genomic data exists that can be verified with respect to the verification key. Accordingly, once the authenticator has obtained such a digital signature, the authenticator can perform the authentication by exchanging messages with the verifier, without the need to involve additional parties at that point. In particular, without the party that has provided the digital signature and thus operates as a source off trust. No identification of the authenticator at that point, whether it be physical or digital, and whether it be to the verifier or to a third party, may be needed. In case the cryptographic proof is a non-interactive proof, the authentication may even just involve the authenticator generating and sharing the cryptographic proof (e.g., uploading the proof to a blockchain or other storage); any party can then, at a point in the future, verify the cryptographic proof to establish authenticity of the public key.

Moreover, the techniques may allow such authentication to be performed with improved privacy. One reason is that identification of the authenticator may be avoided. For example, the verifier may just receive the public key and the cryptographic proof; the cryptographic proof by itself may not allow the verifier to establish the identity of the person on whose behalf the authenticator acts. Especially if the proof is zero-knowledge, this may be guaranteed in a mathematically strong way.

Interestingly, also the party that has issued the digital signature may not be involved, and accordingly does not need to be aware that the genomic data is used to authenticate the public key. And even if the party that has issued the digital signature at a later point observes the cryptographic proof and the public key, the party may not be able to link those to particular genomic data for which it has issued a signature. In fact, even the verifier and the party that has issued the digital signature together typically cannot link the public key to the genomic data that the digital signature was issued for. Also if the same genomic data is used to authenticate two different public keys, even with respect to the same verifier, it may not be possible to determine based on the proofs whether or not the same genomic data was used, e.g., the proofs are unlinkable.

As a consequence, it may also be avoided that an external party needs to store, or have access to, both the genomic of the first person and of the second person. For example, no trusted third party is needed to verify that the first and second genomic data have the given degree of kinship. The first and second genomic data may have been sequenced by different organizations, for example. Thus, centralized storage of the genomic data may be avoided altogether. Only the authenticator may use both the first and second genomic data to compute the kinship function, but since the authenticator acts on behalf of the first party, this is preferred over having an external party access both people's genomic data.

Thus, the authentication may result in the public key being authenticated as belonging to a first person with a given degree of kinship to a second person, while leaking little or no other information about the first person. Thus, the first person may remain anonymous (other than the person being known to be a kin of the second person to whom the second genomic data relates). The private/public key is typically generated especially for the purpose of being authenticated and used as belonging to a person with the given degree. The first person typically does not use their regular public key that is also used, e.g., to sign data that reveals his identity. In an embodiment, the private/public key pair is an ephemeral key pair that is generated, authenticated, used once (e.g., to a sign a document), and then discarded. The public key can also be used multiple times however, e.g., to sign multiple consent statements over time.

It is noted that also the privacy of the second person, to whom the second genomic data relates, may be improved. The verifier typically verifies the cryptographic proof with respect to a representation of the second genomic data. In some embodiments, the representation may be the second genomic data itself. In this case, the verifier thus needs to know the second genomic data to verify the cryptographic proof. However, it is also possible to verify the cryptographic proof for example with respect to a hash of the second genomic data, or to prove that the second genomic satisfies a particular property, e.g., contains a particular variation. In such cases, the verifier does not need the second genomic data, and may not need to know who the second person is. This is especially relevant in case the cryptographic proof is verified by a third party, for example, by an external auditor or regulator, or in case the cryptographic proof is part of a transaction on a digital ledger, e.g., a blockchain.

It is noted that, although the provides techniques can improve privacy, there are also inherent limits to the privacy that can be achieved in this setting. For example, if the second person in question has very few close relatives, this inherently means that the first person is known to belong to a small group. In, for example, a scenario where a next of kin must consent to data sharing for individual with only one remaining next of kin, then the identity of that next of kin, while not revealed explicitly due to the techniques provided herein, may be inferred from contextual information outside of the methods control. Still, within these limits, privacy can be improved.

Some embodiments also relate to cryptographic key generation. Various techniques for generating and verifying cryptographic proofs, rely on the use of a computation evaluation key and a computation verification key, respectively. These evaluation and verification keys depend the statement that is to be proven by the cryptographic proof. For example, the cryptographic proof may be a zero-knowledge non-interactive argument of knowledge such as zk-SNARK, as also described elsewhere; such proofs typically require computation evaluation and verification keys. The cryptographic key generation device may generate this key material.

Optionally, the first and second genomic data may both comprise one or more variations indicating how the respective genomic sequences deviate from a reference genome. The kinship function may be computed by comparing respective corresponding variations comprised in the first and second genomic data. Genomic sequences of different persons typically overlap to a great degree; hence, they can be more efficiently stored in terms of deviations from a reference genome. This smaller representation of the first and second genomic data also makes it computationally more efficient to compute a kinship function on the first and second genomic data, leading to more efficient proving, and possibly also more efficient verification and smaller proof size, and smaller and more efficiently generatable key material, if using.

If it is not already known that the first and second genomic data both describe deviations from the same reference genome, the cryptographic proof can prove this fact, e.g., by proving that an identifier of the reference genome in the respective genomic data matches.

Optionally, the one or more variations comprised in the first genomic data are represented in a hash tree (also known as Merkle tree). Generally, a hash tree is a data structure for efficiently verifying, with respect to its root, that particular contents are included in it. In embodiments, the root of the hash tree that includes the variations, may be signed by the digital signature, thereby effectively signing all included variations. Thus, it can be avoided to have to prove correctness of a regular digital signature algorithm over a message including all of the variations; the digital signature can be proven to be correct with respect to just the hash tree.

By using a hash tree, it can be efficiently proven that particular variations used by the kinship function, are included in the first genomic data. Thus, particular variations may be singled out without having to go through the full first genomic data. Using hash trees, it may thus be avoided to have to prove, in the cryptographic proof, correctness of a computation that touches all of the first genomic data. Similarly, also variations of the second genomic data may be represented in a second hash tree and thus it may also be proven that a variation of the second genomic data is comprised in the second hash tree. The respective variations can then be compared, for example. This way, variations can be efficiently singled out from the first and second genomic data and then compared.

Optionally, only a subset of the variations comprised in the first genomic data are compared to corresponding variations comprised in the second genomic data as part of computing the kinship function. This way, a significant performance improvement can be obtained, especially in combination with proving that these variations are comprised in hash trees or similar mechanisms that avoid having to process the full first and second genomic data. This is important especially given the computational overhead that performing a cryptographic proof entails, which would make it expensive to process the full first and second genomic data.

However, as the inventors recognized, when comparing only a subset of variations, it would be beneficial to avoid that the authenticator is able to select a particular subset of variations that works to his advantage for computing the kinship function. Otherwise, there may be a risk that the kinship function indicates that the first and second genomic belong to kin where this is not in fact the case.

To avoid that the authenticator is able to select a particular subset, the authenticator may prove in the cryptographic proof that a compared variation is comprised in a given set of variations suitable for kinship inference. This way, the authenticator cannot just select any variation but is forced to use variations comprised in this set, reducing the risks of kinship being incorrectly indicated.

Instead or in addition, the subset of variations of the first genomic data may be compared not just to corresponding variations in the second genomic data, but also to corresponding variations comprised in further genomic data. This way, it may be proven that the first genomic data does not have a given degree of kinship with the further genomic data. The further genomic may be generated from the second genomic data by introducing deviations to the second genomic data according to a statistical model of deviation likelihoods.

This reduces the risk that the authenticator wrongly proves kinship by targeting variations that are less unique and that are thus more likely to match between the first and second genomic even if they are not of kin. By adding deviations to the further genomic data according to their deviation likelihood, e.g., with respect to a reference genome, a less unique variation would be more likely to occur in the further genomic data, and would thus likely not contribute to proving that the first and further genomic data do not have the given degree of kinship. On the other hand, a more unique variation would be less likely to occur in the further genomic data, would thus likely contribute to proving that the first and further genomic data do not have the given degree of kinship. Thus, these measures discourage the use of less unique variations.

Optionally, the authenticator further obtains a document (e.g., a consent statement), and generates a digital signature on the document that is verifiable using the public key being authenticated. The document may be signed with the private key corresponding to this public key. The cryptographic proof and the signature together provide evidence to a verifier that a person with a given degree of kinship to the second person, with respect to whose genomic information the proof is verified, has signed the document. The verifier just needs to trust that the verification key only verifies successfully with respect to authentic genomic data. The authenticator may generate the private/public key pair specifically for signing the document and may delete at least the private key afterwards, e.g., the private/public key pair may be an ephemeral key pair for signing the document. When a non-interactive cryptographic proof is used, the proof and the digital signature on the document together may be regarded as forming a “kinship signature” with respect to the second genomic data: a signature proving that the document has been signed by a kin (with a given degree of kinship) of the person having the second genomic data.

The cryptographic proof may be a zero-knowledge proof. The zero-knowledge property is beneficial because it provides guarantees, in a mathematical sense, that no information about the used witnesses (e.g., the first genomic data and the digital signature on it) leaks from the cryptographic proof.

The cryptographic proof may, instead of or in addition, be a non-interactive proof. A non-interactive proof may be constructed by the authenticator and sent to the verifier, who may verify the proof without further interaction with the authenticator. In many cases, anybody can verify the proof. Thus, the same non-interactive proof can be used to convince multiple verifiers. This can be particularly useful for example in a distributed ledger setting such as a blockchain, in which various participants may act as verifiers, or in setting where the cryptographic proof (e.g., the consent to process genomic information) may be verified at a later time. It is also useful in case it is not known, at the time when the cryptographic proof is generated, who will be the verifier, e.g., who will be the auditor. Designated-verifier non-interactive proofs are also possible however.

Generally, the proofs used herein can be so-called “arguments of knowledge”, in which case a small probability of wrongly convincing a verifier may be allowed.

Specifically, the cryptographic proof may be a zero-knowledge non-interactive argument of knowledge. Various such cryptographic proofs are known in the literature, many of which provide appealing properties from a performance point of view. An example is the Bulletproofs proof system disclosed in B. Bünz et al., “Bulletproofs: Short Proofs for Confidential Transactions and More” (available at https://eprint.iacr.org/2017/1066 and incorporated herein by reference). The proof may more specifically be a zero-knowledge succinct non-interactive argument of knowledge (zk-SNARK), e.g., as disclosed in B. Parno et al., “Pinocchio: Nearly Practical Verifiable Computation” (available at https://eprint.iacr.org/2013/279 and incorporated herein by reference), or similar. zk-SNARKs are particularly appealing from the point of view of proof size and verification effort, but typically require computation evaluation and verification keys generated by a key generation device operated by a party trusted by the verifier.

Optionally, the cryptographic proof may prove with respect to a set of multiple verification keys that the digital signature successfully verifies with respect to at least one of those keys. The proof may not reveal which key was used, and thus, it can be hidden from the verifier with respect to which of the verification keys the first genomic data was digitally signed. Similarly to using a single verification key, the proof may be verifiable with respect to the set of verification keys, or the of verification keys can be hard-coded, for example. This can further improve the privacy of the first genomic data. For example, the verification key may be a key belonging to a particular party such as a genomic sequencing service, hospital, or the like. Not knowing which party signed the first genomic data can help keep the first person remain anonymous, which may be important especially because the fact the first and second persons have a given degree of kinship, already greatly restricts who the first person can be.

Optionally, the public key may be generated using the same device and/or in the same method as performing the authentication. Accordingly, the public/private key pair may be a fresh key pair. This is preferred over the use of a public key that has been used previously and/or generated externally, because of making it harder to link the public key to the first person.

An embodiment of the method may be implemented on a computer as a computer implemented method, or in dedicated hardware, or in a combination of both. Executable code for an embodiment of the method may be stored on a computer program product. Examples of computer program products include memory devices, optical storage devices, integrated circuits, servers, online software, etc. Preferably, the computer program product comprises non-transitory program code stored on a computer readable medium for performing an embodiment of the method when said program product is executed on a computer.

In an embodiment, the computer program comprises computer program code adapted to perform all the steps of an embodiment of the method when the computer program is run on a computer. Preferably, the computer program is embodied on a computer readable medium.

Another aspect of the invention provides a method of making the computer program available for downloading. This aspect is used when the computer program is uploaded into, e.g., Apple's App Store, Google's Play Store, or Microsoft's Windows Store, and when the computer program is available for downloading from such a store.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings:

FIG. 1 schematically shows an example of an authentication system;

FIG. 2a schematically shows an example of an embodiment of a cryptographic authentication device;

FIG. 2b schematically shows an example of an embodiment of a cryptographic verification device;

FIG. 3 schematically shows an example of genomic data represented as a hash tree;

FIG. 4 schematically shows an example of verifying non-kinship with respect to further genomic data;

FIG. 5 schematically shows an example of an embodiment of a cryptographic authentication method;

FIG. 6 schematically shows an example of an embodiment of a cryptographic verification method;

FIG. 7 schematically shows an example of an embodiment of a cryptographic key generation method;

FIG. 8 schematically shows a computer readable medium having a writable part comprising a computer program according to an embodiment,

FIG. 9 schematically shows a representation of a processor system according to an embodiment.

### LIST OF REFERENCE NUMERALS

100 an authentication system
110, 210 a cryptographic authentication device
111, 211, 411 a cryptographic verification device
112 a cryptographic key generation device
113 a genomic data certifying device
130, 131, 132 a memory
140, 141, 142 a processor
150, 151, 152 a network interface
160 a computer network
070 a verification private key
071 a verification public key
072 a private key belonging to a first person
073 a public key belonging to a first person
074 a digital signature on first genomic data
075 a document
076 a digital signature on the document
077 a cryptographic proof
078 key material (computation evaluation+verification key)
080 first genomic data of a first person
081 second genomic data of a second person
082 further genomic data
241 a key generation unit
242 a signing unit
243 a proving unit
244, 444 a proof verifying unit
245 a signature verifying unit
446 a deviation generating unit
300 a hash tree
310, 320-321, 330-333 a node of a hash tree
341 a position of a variation
342 a deviation
800 a computer readable medium
810 a writable part
820 a computer program
910 integrated circuit(s)
920 a processing unit
922 a memory
924 a dedicated integrated circuit
926 a communication element
930 an interconnect
940 a processor system

### DETAILED DESCRIPTION OF THE EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

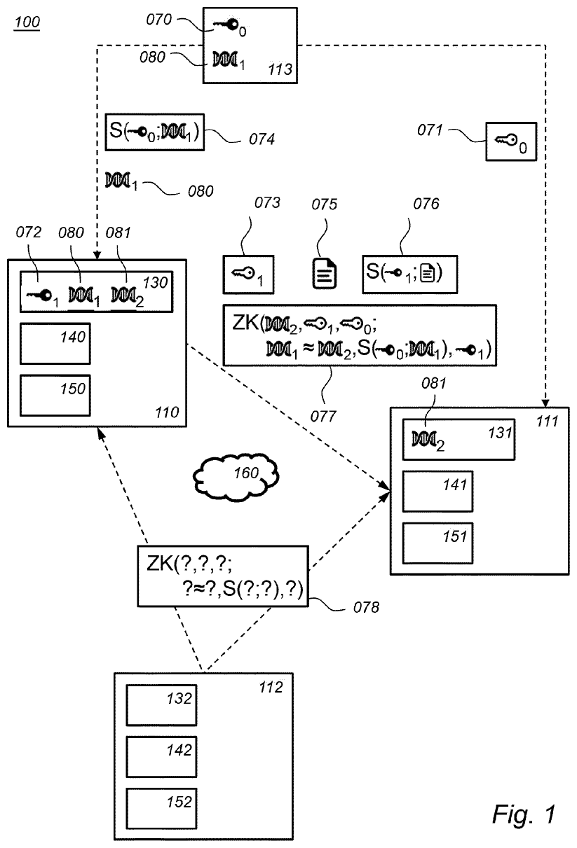

FIG. 1 schematically shows an example of an embodiment of a cryptographic authentication system 100 for authenticating a public key 073. The authentication may be for proving that the public key 073 belongs to a first person with a given degree of kinship to a second person. System 100 may comprise at least a cryptographic authentication device 110 for use in the system, and a cryptographic verification device 111 for use in the system. The system 100 can optionally comprise a genomic data certifying device 113. The system 100 can optionally comprise a cryptographic key generation device 112 for use in the system.

For the purpose of explication, FIG. 1 shows various elements that may be stored by the devices of system 100 at various stages of its operation. In the figure, key symbols are used to denote cryptographic keys; black keys denote public keys and white keys denote private keys, indices being used to indicate which public and private keys together form a private/public key pair. For example, keys 070 and 071 are private and public keys, respectively, of one key pair; and keys 072 and 074 are private and public keys, respectively, of another key pair. Digital signatures 074, 076 are illustrated in the figure as boxes with text “S(A;B)”. Here, A denotes the private key used to sign, and B denotes the message that is signed.

Cryptographic authentication device 110 may be for authenticating public key 073. Cryptographic authentication device 110 may comprise a memory 130 and a processor 140. Memory 130 may be used for data and/or instruction storage. For example, memory 130 may comprise software and/or data on which processor 140 is configured to act. Memory 130 may also be arranged for storing first genomic data 080 representing a genomic sequence of the first person. Memory 130 may also be arranged for storing a digital signature 074 on the first genomic data 080, verifiable with respect to a verification key 071. Memory 130 may also be arranged for storing second genomic data 081 representing a genomic sequence of the second person. Memory 130 may also be arranged for storing additional information needed by device 110, e.g., the public key 073 to be authenticated and/or the corresponding private key 072.

Processor 140 may be implemented as one or more processor circuits, e.g. microprocessors, ASICs, FPGA and the like. Memory 130 may comprise computer program instructions which are executable by processor 140. Processor 140, possibly together with memory 130, is configured according to an embodiment of a cryptographic authentication device. Cryptographic authentication device 110 may also comprise a communication interface 150 arranged to communicate with other devices, in particular, cryptographic verification device 111. For example, the communication interface may comprise a connector, e.g., a wired connector, e.g., an Ethernet connector, or a wireless connector, e.g., an antenna, e.g., a Wi-Fi, 4G or 5G antenna. The communication interface may also be a storage interface to an internal or external data storage, a keyboard, an application interface (API), etc.

Cryptographic authentication device 110 may be configured to generate a cryptographic proof 077. The cryptographic proof 077 may be verifiable with respect to at least the public key 073. The cryptographic proof 077 may prove that the public key 073 belongs to a person with the given degree of kinship to the second person. To this end, the cryptographic proof 077 may prove that the first genomic data 080 and the second genomic data 081 have the given degree of kinship, as computed by a kinship function on the first and second genomic data 080, 081. The cryptographic proof 077 may also prove that the digital signature 074 verifies successfully with respect to the first genomic data 080 and the verification key 071.

The cryptographic proof 077 is visualized in the figure as a box 077 being provided by cryptographic authentication device 110 to cryptographic verification device 111. The cryptographic proof 077 can be provided by device 110 to device 111 in a single message, e.g., the proof can be a non-interactive cryptographic proof. However, the cryptographic proof can also be an interactive proof in which parties 110 and 111 both send data to each other, e.g., a 3-pass protocol in which device 110 sends a first message of the proof 077; device 111 replies by sending a second message (often referred to as a challenge); and device 110 replies by sending a third message (often referred to as a response). The contents of the cryptographic proof 077 are diagrammatically represented in the figure by the text “ZK(A;B)”, where A represents information with respect to which the proof 077 is verifiable, and B represents information that is proven to satisfy certain properties with respect to the information A. The information B is typically referred to as the “witness” of proof 077. The verifier typically does not know the witness B. The proof 077 may be a zero-knowledge proof, in which case it is mathematically guaranteed that proof 077 does not leak information about the witness. The definition of the properties to be proven and the information with respect to which the properties are proven, are known as the “statement” of the proof.

As shown in the figure, the proof may be verifiable with respect to at least the public key 073. The proof can optionally also be verifiable with respect to the verification key 071. Accordingly, the verification device 111 may verify the authentication of the public key 073 based on trusting that the provided verification key 071 is only used to sign authentic genomic data; in this case, genomic data 080. Typically, the proof is also verifiable with respect to a representation of the second genomic data. The figure shows second genomic data 081 itself being included in the statement of the proof 077, but this is not necessary; alternatives are discussed throughout.

As also shown in the figure, the witness of the proof may include the first and second genomic data 080, 081; and signature 074 on the first genomic data 080. In the example shown in this figure, the public key 073 is authenticated by including the corresponding private key 072 in the witness; the proof 077 may then prove that the private key 072 corresponding to the public key 073 is input to the cryptographic proof, in other words, that the authentication device 110 knows the private key 072. As also discussed elsewhere, this is not necessary, and also other means are possible to link the public key 073 to the proof 077, e.g., by using a proof 077 that is a signature of knowledge, as also discussed elsewhere.

Cryptographic verification device 111 may be for verifying the authentication of the public key 071. Cryptographic verification device 111 may comprise a memory 131 and a processor 141. Memory 131 may be used for data and/or instruction storage. For example, memory 131 may comprise software and/or data on which processor 141 is configured to act. Memory 131 may also be arranged for storing the public key 073 to be authenticated. Memory 131 may also optionally be arranged for storing a verification key 071 suitable for verifying a digital signature 074 on first genomic data 080 representing a genomic sequence of the first person. Memory 131 may also be arranged for storing second genomic data 081, or a representation of second genomic data 081 used to verify the cryptographic proof 077 against.

Processor 141 may be implemented as one or more processor circuits, e.g. microprocessors, ASICs, FPGA and the like. Memory 131 may comprise computer program instructions which are executable by processor 141. Processor 141, possibly together with memory 131, is configured according to an embodiment of a cryptographic verification device. Cryptographic verification device 111 may also comprise a communication interface 151 arranged to communicate with other devices, in particular, cryptographic authentication device 111. For example, the communication interface may comprise a connector, e.g., a wired connector, e.g., an Ethernet connector, or a wireless connector, e.g., an antenna, e.g., a Wi-Fi, 4G or 5G antenna. The communication interface may also be a storage interface to an internal or external data storage, a keyboard, an application interface (API), etc.

Cryptographic verification device 111 may be configured to obtain cryptographic proof 077, and to verify the cryptographic proof with respect to at least the public key 073. As shown in the figure, the proof 077 may be verified in addition with respect to the verification key 071 and/or with respect to second genomic data 081 or a representation of the second genomic data.

As shown in the figure, authentication device 110 may provide the cryptographic proof 077 to the verification device 111. This can be in the form of a message to, or an interactive proof with, the verification device 111. The authentication device 110 may also provide the proof 077 by uploading it to a storage, for example for verification at a later date. At this point in time, the authentication device 110 may not even know the identity of the verification device 111 that will verify proof 077 later on, and may thus not be sending the proof to any particular verifier. Along with the cryptographic proof, authentication device 110 may further provide the public key 073 to be authenticated; e.g., the authentication device 110 may generate the private/public key pair of keys 072, 073 itself.

As shown, the authentication device 110 may optionally also provide, to the verification device 111, a document 075 (e.g., a consent statement) and/or a digital signature 076 on that document, signed with private key 072 and verifiable with corresponding public key 073. Accordingly, public key 073, signature 076, and cryptographic proof 077 may together provide an authentication of document 075 as being signed by a person with a given degree of kinship with the second person corresponding to the second genomic data 081. Public key 073 does not need to be used to sign documents, however, e.g., it can be used for authentication, e.g., logging in.

Also shown in the figure is a genomic data certifying device 113. As discussed, the proof 077 may be with respect to a verification key 071 for verifying digital signature 074 on first genomic data 080. The digital signature may be generated by the genomic data certifying device 113 using private key 070 corresponding to the public verification key 071. The genomic data certifying device 113 can be a conventional device for signing digital messages, e.g., operated by a genomic sequencing service, by a hospital, by a notary, or another party trusted by the verifier. The genomic data certifying device 113 may provide (directly or indirectly) the digital signature 074 on the first genomic data 080 to the authentication device 110. The genomic data certifying device 113 may also provide the first genomic data 080 to the authentication device 110, but conversely, the authentication device 110 may also provide the first genomic data 080 to the genomic data certifying device 113 for signing. The genomic data certifying device 113 may also provide (directly or indirectly) the verification key 071 to the verification device 111.

It is noted that, interestingly, although genomic data certifying device 113 has access to the first genomic data 080 at some point for signing it, the genomic data certifying device 113 does not need access to second genomic data 081 in order for the authentication to work. Also, apart from providing key 071 and signature 074 at some point prior to the authentication, genomic data certifying device is not typically involved in the authentication itself. In fact, given the information it has, genomic data certifying device 113 in some embodiments is not able to link first genomic data 080 to the cryptographic proof 077, nor able to link the first genomic data 080 to the key 073 or the document 075 based on the proof 077.

Also shown in the figure is a cryptographic key generation device 112 for generating key material 078 for authenticating public keys. Device 112 may be combined with device 111, e.g., to generate key material used later to verify proofs. Cryptographic key generation device 112 may comprise a memory 132 and a processor 142. Memory 132 may be used for data and/or instruction storage. For example, memory 132 may comprise software and/or data on which processor 142 is configured to act. Memory 132 may also be arranged for storing the generated key material. The key material may comprise a computation evaluation key for generating a cryptographic proof (also known as a proving key) and a computation verification key for verifying the cryptographic proof (also known as a verifying key).

Processor 142 may be implemented as one or more processor circuits, e.g. microprocessors, ASICs, FPGA and the like. Memory 132 may comprise computer program instructions which are executable by processor 142. Processor 142, possibly together with memory 132, is configured according to an embodiment of a cryptographic key generation device. Cryptographic key generation device 112 may also comprise a communication interface 152 arranged to communicate with other devices, in particular, to provide the computation evaluation key to authentication device 110 and/or to provide the computation verification key to verification device 111. For example, the communication interface may comprise a connector, e.g., a wired connector, e.g., an Ethernet connector, or a wireless connector, e.g., an antenna, e.g., a Wi-Fi, 4G or 5G antenna. The communication interface may also be a storage interface to an internal or external data storage, a keyboard, an application interface (API), etc.

Cryptographic key generation device 112 may be configured to generate key material 078 suitable for generating and verifying the cryptographic proof 077. The key material is shown schematically as a template, as indicated by the question marks, in which the cryptographic proof 077 can be filled in. At least the first genomic data 080, the second genomic data 081, and the public key 073 can typically be varied, e.g., are inputs (witnesses or verification inputs) of the proof to be generated and verified using key material 078. Accordingly, this genomic data and public keys are typically not input to the key generation process. Although it is beneficial for flexibility if also the verification key 071 can be varied, it is also possible to hard-code the verification key 071 in key material 078. In this case, cryptographic key generation device 112 may obtain the verification key 071 as an input.

Cryptographic key generation device 112 may use techniques for generating key material 078 for generating and verifying cryptographic proofs that are known per se. Such techniques typically take as input a description of a computation whose correct execution can be proven using the generated key material. For example, the description can be a low-level description in terms of a circuit of a computation to be performed (e.g., an arithmetic circuit or a binary circuit), or of set of equations to be verified (e.g., quadratic equations). The description can also be a high-level description that is compiled into such a low-level description by a compiler component of the key material generator. Based on such a description, the key material may be generated. Various known key material generating techniques can be used, such as the Pinocchio prototype as described in the paper “Pinocchio: Nearly Practical Verifiable Computation”; a combination of MIT's libsnark library with a high-level logical circuit compiler such xjSNARK; or the PySNARK library available at https://github.com/Charterhouse/pysnark.

Generally, such key material generation techniques support a wide range of computations, and accordingly, using the key generation material, proofs for a wide range of computations can be generated and verified. In particular, various known key material generation techniques support basic primitives for proving that data occurs in a hash tree, that a digital signature correctly verifies, that a private key corresponding to a public key is known, etcetera. Various proofs as described herein can be implemented in terms of these basic primitives.

Specifically, for cryptographic key generation device 112, the computation that is input into the key generating technique may be a computation that verifies that first genomic data and second genomic data have a given degree of kinship, as computed by a kinship function on the first and second genomic data; and that verifies that a digital signature verifies successfully with respect to the first genomic data and a verification key.

The cryptographic key generation device 112 may provide the generated key material 078 to the other parties, e.g., it may provide the computation evaluation key to the authentication device 110 and/or the computation verification key to verification device 111. Interestingly, in many cases, the generated key material 078 does not need to be kept secret, e.g., it can be used by multiple authenticating devices and/or verification devices, and can be made publicly available, e.g., the generated key material 078 may be provided to the other parties by uploading it to a publicly accessible storage.

The various devices of system 100 communicate with each other over a computer network 160. The computer network may be an internet, an intranet, a LAN, a WLAN, etc. Computer network 160 may be the Internet. The computer network may be wholly or partly wired, and/or wholly or partly wireless. For example, the computer network may comprise Ethernet connections. For example, the computer network may comprise wireless connections, such as Wi-Fi, ZigBee, and the like. Computer network 160 may comprise additional elements, e.g., a router, a hub.

The various devices of FIG. 1 may have respective user interfaces, which may include well-known elements such as one or more buttons, a keyboard, display, touch screen, etc. For example, the user interface of the verifier device 112 may be arranged for accommodating user interaction for initiating a verification of a public key 073 or a document 075 signed by it.

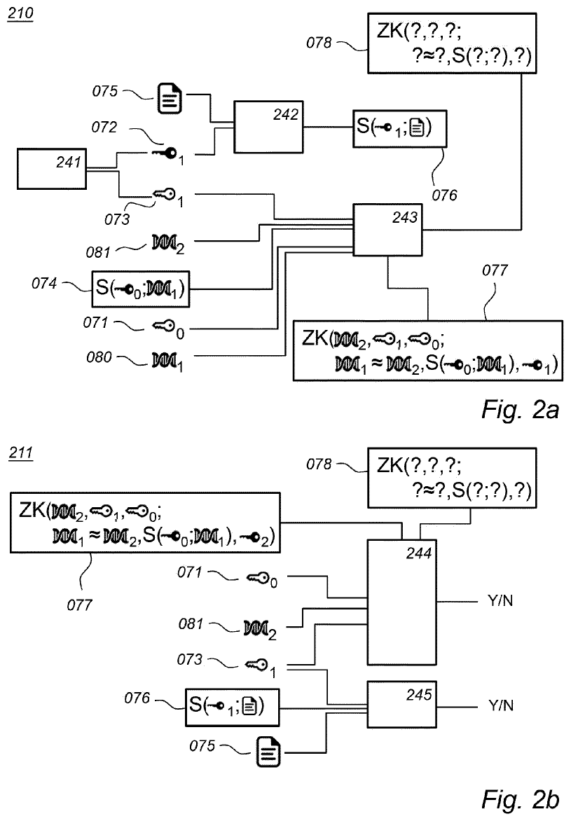

FIG. 2a schematically shows an example of an embodiment of a cryptographic authentication device 210 for authenticating a public key 073. The authentication may be for proving that public key 073 belongs to a first person with a given degree of kinship to a second person. For example, the authentication device may be operated by a family member of the second person who wants to authenticate as such, e.g., for providing consent based on this family membership. The cryptographic authentication device may be for use in an authentication system according to an embodiment, e.g., authentication system 100 of FIG. 1. E.g., the cryptographic authentication device may be based on cryptographic authentication device 110 of FIG. 1.

FIG. 2a schematically shows functional units that may be functional units of a processor of cryptographic authentication device 210 (not shown separately). For example, FIG. 2a may be used as a blueprint of a possible functional organization of the processor. For example, the functional units shown in FIG. 2, e.g., units 241-243, may be wholly or partially be implemented in computer instructions that are stored at device 210, e.g., in an electronic memory of device 210, and are executable by a microprocessor of device 210. In hybrid embodiments, functional units are implemented partially in hardware, e.g., as coprocessors, and partially in software stored and executed on device 210. For the purpose of explication, FIG. 2a also shows various elements that may be stored by the device 210 at various stages of its operation.

Shown in the figure is a public key 073 to be authenticated. Public key 073 can be any type of conventional public key, e.g., a DSA public key, an ECDSA public key, an RSA public key, etcetera. The use of an elliptic curve based digital signature scheme such as ECDSA, Ed25519, or elliptic curve-based ElGamal or Schnorr is preferred for allowing to prove signature verification and/or knowledge of private keys relatively efficiently. For example, the secp256r1 curve may be used. Also shown in the figure is a private key 072 corresponding to public key 073, e.g., private key 072 and public key 073 may form a private/public key pair. In some embodiments, cryptographic authentication device 210 does not need access to private key 072 to perform authentication, however.

Also shown is a key generation unit 241. Key generation unit 241 may be configured to generate the private key 072 and the public key 073 as a private/public key pair. Conventional key generation units may be used. The key generation unit 241 is optional, e.g., cryptographic authentication device 210 may instead use an externally generated public key 073. It may be beneficial to combine key generation with authentication in the same device, however, especially if the key pair 072, 073 is used as an ephemeral key since this can mean that the private key 072 does not need to leave the device 210.

Also shown is a signing unit 242. Signing unit 242 may be configured to obtain a document 075 (e.g., a consent statement) and generate a digital signature 076 on the document 075. Conventional signing units may be used. The document may be signed using the private key 072 and may accordingly be verifiable using the public key 073. Also signing unit 242 is optionally, e.g., public key 073 may be authenticated for use by another device and/or the public key 073 may be authenticated for uses other than signing documents.

Also shown is a proving unit 243. Proving unit 243 may be configured to generate cryptographic proof 077. Generally, a cryptographic proof may prove knowledge of a witness satisfying a given statement. The statement may include information to be input by the verifier when verifying the proof. The witness and statement are discussed further below.

A conventional proving unit 243 may be used, configured for proving the statement used to authenticate public key 073. Such a unit may receive as input at least the witness to the proof. The unit typically also receives as input a description of the statement that is to be proven, e.g., of a computation whose correct execution is to be proven. This description can also be hard-coded, however, or it can be or included in a computation evaluation key as described below.

To generate cryptographic proof 077, proving unit 243 may use a computation evaluation key 078. The computation evaluation key 078 may be generated by a cryptographic key generation device according to an embodiment, e.g., cryptographic key generation device 112 of FIG. 1. For example, cryptographic proof 078 can be a zero-knowledge non-interactive argument of knowledge, in which case such a computation evaluation key is typically used. Techniques for implementing a proving unit 243 for generating such types of proofs are available, e.g., from “Pinocchio: Nearly Practical Verifiable Computation”, the libsnark library, or PySNARK.

However, other types of proving techniques are also available, including ones that do not require a computation-dependent computation evaluation key 078. In this case, still, computation-independent key material may be used however. While often less efficient, these techniques have the advantage that there is no need to rely on a trusted party to generate computation-dependent key material. Example of such techniques are disclosed for example in “Bulletproofs: Short Proofs for Confidential Transactions and More”; or in M. Jawurek et al., “Zero-Knowledge Using Garbled Circuits: How To Prove Non-Algebraic Statements Efficiently” (available at https://eprintiacr.org/2013/073 and incorporated herein by reference). Also known techniques for non-zero-knowledge proofs, e.g., interactive proof systems, can be used.

Generally, the proof 077 can either be a non-interactive proof or an interactive proof. In the latter case, proof unit 243 may, in one or more rounds, obtain one or more messages of the interactive proof protocol from the verifier and determine one or more respective responses.

Concerning the witness and statement of cryptographic proof 077, e.g., the computation that the proof 077 proves was performed correctly and the private inputs that were used, the cryptographic proof 077 may prove that public key 073 belongs to a person with the given degree of kinship to a second person by proving several statements. The statements can be combined into a single cryptographic proof, or proof 077 can comprise multiple sub-proofs for the respective statements.

The proof 077 may prove that first genomic data 080 and second genomic data 081 have the given degree of kinship. The degree of kinship may be computed by a kinship function on the first and second genomic data. This may be a predefined function indicative of a degree of kinship of the persons to whom the genomic data relate. For example, the degree of kinship may be a kinship overlap degree. Various ways to compute kinship are known per se and can be used here by including them in the statement to be proven. For example, such techniques are discussed in K. Ritland, “Estimators for pairwise relatedness and individual inbreeding coefficients”, Genetics Research, 67, 175-185, 1996; in J. Yang et al., “Common SNPs explain a large proportion of the heritability for human height”, Nature Genetics, 42, 565-569, 2010; and in A. Manichaikul et al., “Robust relationship inference in genome-wide association studies”, Bioinformatics 26 2867, 2010 (all three papers included herein by reference).

In particular, one way to compute kinship, is to express first and second genomic both in terms of deviations from the same reference genome. The kinship function may then be computed by comparing respective corresponding variations (e.g., variations occurring at the same position) comprised in the first and second genomic data. The first and second genomic data may also optionally comprise an identifier of the respective reference genomes being used, with the proof proving that these identifiers match. The degree of kinship (e.g., a maximum difference between the first and second genomic data) may be input to the statement by the verifier, but it can also be hard-coded. Various particularly advantageous choices are discussed further elsewhere in this specification.

The first genomic data 080 is typically a witness of the authentication device 210. That is, the verifier does not need the first genomic data to verify the proof 077, and if the proof 077 is a zero-knowledge proof, it does not leak information about the first genomic data 080 except as implied by the statement that is proven about it.

Also a digital signature 074 on the first genomic data 080 may be a witness of the authentication device 210. The digital signature 074 may be verifiable with respect to a verification key 071. The verification key 071 is typically part of the statement, either as an input by the verifier, or hard-coded into the statement. For the verification key 071, the digital signature scheme options discussed with respect to public key 073 also apply.

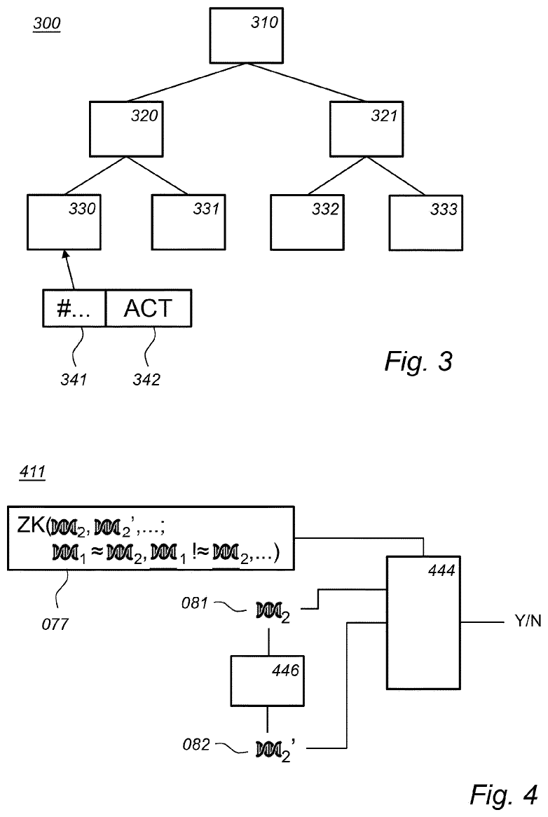

The proof 077 may then prove that the digital signature 074 verifies successfully with respect to the first genomic data 080 and the verification key 071. For example, the computation whose correctness is verified by the cryptographic proof 077, may include a signature verification algorithm for verifying signatures with respect to the verification key, e.g., an ECDSA or Schnorr signature verification. It is also possible to have a set of multiple verification keys being comprised in the statement (hardcoded and/or input by the verifier), with the proof proving that one of the multiple verification keys can be used to successfully verify the digital signature 074, without specifying to the verifier which verification key it was. This is further discussed w.r.t. FIG. 3.

The signature may be a signature on a root of a hash tree representing the first genomic data 080 (e.g., in terms of variations to a reference genome, as also discussed elsewhere). The signature may then be verified by verifying that that the root of the hash tree was signed correctly, and by proving that those parts of the first genomic data 080 that are being used in the kinship function (e.g., a subset of the variations) are comprised in the hash tree. This has the advantage that parts of the first genomic data 080 that are not used to compute kinship, also do not need to be considered for verifying the signature.

Typically, a representation of the second genomic data 081 is input by the verifier of the proof 077, and is thus included in the statement. For example, the second genomic data itself may be a public input of the verifier. There are also various other options, for example, the representation of the second genomic data 081 that is input by the verifier may be a root of a hash tree representing the second genomic data, similarly to the first genomic data. Further examples are given with respect to FIG. 2b. The proof may comprise proving that the second genomic data 081 that are used to compute the kinship function, match the representation of the second genomic data that is input by the verifier, e.g., that the portions of the second genomic data that are used in the kinship function, occur in the hash tree.

Optionally, also the private key 072 corresponding to the public key 073 to be authenticated, may be a witness to the proof 077. The proof may then prove knowledge of this private key. Accordingly, it may be guaranteed to the verifier that the party determining the proof, also holds the private key. Depending on the proof techniques used, using the private key as a witness may also make it harder for another party to take proof 077 and modify it to become a proof with respect to a different public key. Accordingly, the computation verified in proof 077 may comprise the computation of public key 073 from private key 072, or another type of verification that public key 073 and private key 072 form a private/public key pair.

As a concrete example, the cryptographic proof may prove that the computation represented by the following pseudocode was performed correctly:

```
snark_f(
  public: [DNA2, SigKey, FamKey, Degree], // second DNA data; verification key;
    // public key; degree of kinship
  private: [DNA1, Signature, PrivKey]) // first DNA data; signature on first DNA data;
    // private key corresponding to public key
{
  // Compute kinship overlap degree and compare to publicly defined kinship parameter
  CHECK(kinship(DNA1,DNA2)<Degree);
  // Verify that DNA2 was obtained from trustworthy source w.r.t. publicly defined source of trust
  CHECK(verifysig(DNA1,Signature,SigKey));
  // Verify that the proposed public key is based on a secret key known by the prover.
  CHECK(FamKey == (G\hat{ }PrivKey));
}
```

FIG. 2b schematically shows an example of an embodiment of a cryptographic verification device 211 for verifying an authentication of a public key 073. The authentication may be for proving that the public key belongs to a first person with a given degree of kinship to a second person. For example, the cryptographic verification device 211 may be operated by an auditor or regulator to verify whether consent to process genomic information of the second person is in place. The cryptographic verification device may be for use in an authentication system according to an embodiment, e.g., authentication system 100 of FIG. 1. For example, the cryptographic verification device may be based on cryptographic verification device 111 of FIG. 1.

FIG. 2b schematically shows functional units that may be functional units of a processor of cryptographic verification device 211 (not shown separately). For example, FIG. 2b may be used as a blueprint of a possible functional organization of the processor. For example, the functional units shown in FIG. 2, e.g., units 244-245, may be wholly or partially be implemented in computer instructions that are stored at device 211, e.g., in an electronic memory of device 211, and are executable by a microprocessor of device 211. In hybrid embodiments, functional units are implemented partially in hardware, e.g., as coprocessors, and partially in software stored and executed on device 211. For the purpose of explication, FIG. 2b also shows various elements that may be stored by the device 211 at various stages of its operation.

Shown in the figure is a cryptographic proof 077 that may be obtained by the cryptographic verification device 211, and a proof verifying unit 244 that may be used to verify the cryptographic proof. Generally, the cryptographic proof 077 may prove that a certain statement is true, with the statement including data that is input by the verifier 211. Specifically, the proof 077 may prove that the party generating the proof, knows a certain witness that satisfies the statement (with respect to the input of the verifier).

Based on the cryptographic proof 077 and the verifier input(s), proof verifying unit 244 may verify the proof 077 with respect to the statement in a conventional way. Optionally, the proof verifying unit may use a description of the statement to be verified, similarly to the proving unit 243 of authentication device 210. For example, this may be the case for a proof verifying unit 244 based on Bulletproofs or on “Zero-Knowledge Using Garbled Circuits”. Instead or in addition, the proof verifying unit 243 may optionally use a computation verification key 078, e.g., generated as key material together with a computation evaluation key by a cryptographic key generation device according to an embodiment. For example, this may be the case when using Pinocchio, pysnark, or similar.

The proof 077 can be non-interactive or interactive; in the latter case, proof verifying unit 244 may be activated multiple times to handle multiple messages provided by the prover (e.g., to generate an additional message to be sent to the prover and/or to perform a verification operation based on the messages sent and received so far). In any case, verifying proof 077 may result in a verification output indicating whether or not the verification device 211 is convinced of the statement and/or the knowledge of the prover.

Specifically, the proof 077 typically has the public key 073 to be authenticated as a verifier input, and may prove that public key 073 belongs to a person with the given degree of kinship to the second person. To this end, the proof 077 may prove that a digital signature verifies successfully with respect to first genomic data representing a genomic sequence of that first person (e.g., input as a witness by the prover), and with respect to a verification key 071. The verification key 071 may be a key of a party trusted by the verifier to vouch for genomic data. Accordingly, the fact that a digital signature verifiable with respect to the verification key exists, may convince the verifier 211 of the authenticity of the genomic material. Interestingly, the verifier typically does not see the digital signature and/or the first genomic data, and accordingly can use neither to link the authenticated public key 073 to a person.

As shown in the figure, the verification key 071 may input to the proof verifying unit 244 by the verification device 211; but it is also possible for the verification key to be hard-coded into the statement, e.g., be incorporated in computation verification key 078, if using.

The proof 077 may further prove that the first genomic data represents a genomic sequence of the first person with a given degree of kinship with second genomic data 081 representing a genomic sequence of the second person, e.g., as computed by a kinship function on the first and second genomic data. The degree of kinship may be input to the proof by the verifier 211, but it can also be hard-coded.

Typically, also a representation of the second genomic data is input into the proof verifying unit 244. There are several options for this. The representation can be the second genomic data 081 itself, as also shown in the figure. The representation can also be, for example, a root of a hash tree representing the second genomic data, e.g., in terms of variations to a reference genome. Other possible representations include a hash of the second genomic; a digital signature of the second genomic verifiable with respect to a (hardcoded or input) further verification key; and so on. The digital signature can be a digital signature on the root of the hash tree, a hash tree of signatures of leaf nodes, etc. Another representation may be a cryptographic accumulator with entries representing portions of genomic data, e.g., variations with respect to a reference genome.

These various possibilities may in particular allow contents of the second genomic data to remain hidden from the verifier, which is important for blockchain applications and similar. Using these or other representations of the second genomic data that are smaller than the data itself can also have the advantage of reducing verification effort, which typically scales directly in the size of the inputs provided by the verifier but less so or not at all in the size of the computation.

Also shown in the figure is an optional signature verifying unit 245. Given the authenticated public key 073, a document 075, and a digital signature 076 on that document 075 verifiable with that public key 073, the signature verifying unit 245 may be arranged to verify the digital signature. The combination of the outcome of the proof verification by unit 244 and the signature verification by unit 245 may indicate whether the document is correctly signed by a person with a given degree of kinship to the person holding second genomic data 081, as indicated by the genomic data. To improve performance, it is possible to skip verification of proof 077 if digital signature 076 is not valid or to skip verification of digital signature 076 if proof 077 is not valid.

FIG. 3 schematically shows an example of an embodiment of a hash tree 300 for use to represent first or second genomic data, e.g., for use by cryptographic authentication device 110 or 210, or cryptographic verification device 111 or 211. For example, the digital signature on the first genomic data that is used by a cryptographic authentication device as described herein, may be a signature on a hash tree 300; specifically, a signature on its root node. Instead or in addition, the representation of the second genomic data that is used to verify a cryptographic proof by a cryptographic verification device as described herein, may be based on a hash tree 300, specifically on its root node. Hash trees are also commonly referred to as Merkle trees.

Specifically, in embodiments illustrated by this figure, the genomic data may represent a genomic sequence of a person in terms of variations indicating how the genomic sequence deviates from a reference genome. For example, the variations may be so-called single-nucleotide polymorphisms (SNPs or SNIPs) or similar. Accordingly, the kinship function between first and second genomic data may be computed by comparing respective corresponding variations comprised in the first and second genomic data.

For example, the variations may be represented by, or derived from, lines of a Variant Call Format (VCF) file. As is known in bioinformatics, a VCF file may be used to store gene sequence variations with respect to a reference genome. Optionally, a VCF file can also store phenotype information. A portion of a VCF file is shown below:

| #CHROM | POS ID | REF ALT QUAL | FILTER INFO | | | | FORMAT | | |
|---|---|---|---|---|---|---|---|---|---|
| chr1 | 82154 | rs4477212 | a | . | . | . | . | GT | 0/0 |
| chr1 | 752566 | rs3094315 g | A | . | . | . | GT | 1/1 | |
| chr1 | 752721 | rs3131972 A | G | . | . | . | GT | 1/1 | |
| chr1 | 798959 | rs11240777 | g | . | . | . | . | GT | 0/0 |
| chr1 | 800007 | rs6681049 T | c | . | . | . | GT | 1/1 | |
| chr1 | 838555 | rs4970383 | c | . | . | . | . | GT | 0/0 |
| chr1 | 846808 | rs4475691 | C | . | . | . | . | GT | 0/0 |
| chr1 | 854250 | rs7537756 | A | . | . | . | . | GT | 0/0 |

For example, each line of the VCF file can correspond to a variation. The hash tree 300 may then represent the genomic data by containing the one or more variations to the reference genome, comprised in the genomic data. When a variation is used in the computation of the kinship function, it may be proven that this variation is comprised in the hash tree.

By way of illustration, a hash tree 300 is shown. Leaf nodes of hash tree 300, in this case, leaf nodes 330, 331, 332, and 333, may represent variations of the genomic data. For example, the genomic data may comprise at least 500, at least 1000, or at least 10000 variations and accordingly, the hash tree may comprise at least this many leaf nodes. The leaf nodes do not all need to occur at the same level of the hash tree. There may also be leaf nodes that represent other information than variations, e.g., phenotype information, etc. The hash tree may comprise a leaf node identifying the reference genome used; in the cryptographic proof, it may be proven using this leaf node that the first and second DNA data use the same reference genome and/or that a particular reference genome is used in the first and/or second DNA data.

A variation may be represented by a position 341 and a deviation 342 indicating whether or not, at position 341, the represented genomic sequence deviates from the reference genome, and if so, optionally, what the deviation is. A variation can be represented as a line of a VCF file, for example, as also discussed elsewhere. Typically, a leaf node 330 represents its variation 341-342 as a hash of information representing the variation, e.g., a hash of a VCF line.

It is possible to include just variations where there is a deviation from the reference genome in the hash tree 300, but it is also possible to include also variations where there is no deviation, which may be useful to be able to show that there is no deviation at a certain position (this may otherwise require to show that a variation does not occur in the hash tree, e.g., by including an index of positions that are included).

A non-leaf node of the hash tree may represent the subtree rooted at the node as a hash of its child nodes. For example, node 320 may be represented by a hash of leaf nodes 330, 331; node 321 may be represented by a hash of leaf nodes 332, 333; and root node 310 may be represented by a hash of non-leaf nodes 320 and 321. A conventional hash such as SHA-256 can be used. The number of child nodes of a node does not need to be 2: it can also be 1 or more than 2. The hash tree illustrated has three levels, but in general, any number of levels is possible, e.g., at least 8, at least 12, or at least 16.

Accordingly, the root node 310 of the hash tree may represent the full hash tree. Using known techniques, it can be efficiently proven in a cryptographic proof that a variation represented by a given leaf node occurs in the hash tree based on the siblings of the nodes along the path from the leaf node to the root node. For example, it may be proven that variation 341-342 occurs in the hash tree with root 310 based on the hashes of nodes 331 and 321 by hashing variation 341-342; concatenating the result with node 331 and hashing the result; concatenating this with node 321; hashing the result and checking that it corresponds to root node 310.

Embodiments based on a hash tree may allow to address the problem that genomic data can be relatively large, and that accordingly, it can be inefficient to generate and/or verify proofs relating to such genomic data. In particular, representing the second genomic data as a hash tree may allow the verifier to avoid inputting the full second genomic data into the verification. This is particularly important in settings where the verifier may have to verify many proofs, e.g., in blockchain applications. Moreover, representing the first and/or second genomic data as a hash tree may allow the prover to more efficiently prove correctness of the computation of the kinship function, especially if the kinship function does not use all variations comprised in the first and/or second genomic data. This is important since various performance metrics of cryptographic proofs, such as the proof size, proving time, and/or computation evaluation key size, typically scale in the size of the computation, e.g., linearly or worse.

Interestingly, the inventors envisaged to use a kinship function that computes the degree of kinship based on only a subset of the variations comprised in the first and/or second genomic data. For example, in embodiments, at most 10%, at most 5%, or even at most 1% of variations may be used to compute the kinship function. Instead or in addition, between 20 and 60% or more preferably, between 30% and 50%, of an overlapping subrange of the genomic information is used. This is especially beneficial in terms of performance in combination with hash trees, since it means that, in the cryptographic proof, computations scaling in the overall number of variations may be avoided altogether.

Interestingly, even when taking a subset of variations, an accurate degree of kinship may be determined. It is known in the literature that kinship inference is largely determined by overlaps in very specific variations, e.g., see G Kale et al., “A utility maximizing and privacy preserving approach for protecting kinship in genomic databases”, doi: 10.1093/bioinformatics/btx568 (incorporated herein by reference). Accordingly, the computation of the kinship function may be based on a subset of most relevant variations of the first and second genomic data, with a hash tree 300 being used to prove that these variations are comprised in the genomic data.

As an illustration, using a hash tree 300, the following computation may be proven to be correctly executed in a cryptographic proof:

| | |
|---|---|
| snark_f( | // see previous pseudocode example |

```
  public: [RM_DNA2, SigKey, FamKey, Degree], // RM_DNA2: root
  of hash tree for DNA2
  private: [RMD_NA1, SNIPS1, PATHS1, SNIPS2, PATHS2, Signature,
  PrivKey])
```

// RM_DNA2: root of hash tree for DNA1; SNIPS*,

```
PATHS*: hash tree authentication data
{
  for ((SNIP, PATH): (SNIPS1, PATHS1)) { // hash tree authentication
    CHECK(MERKLEPATH(SNIP, RM_DNA1, PATH));
  }
  for ((SNIP, PATH): (SNIPS2, PATHS2)) { // hash tree authentication
    CHECK(MERKLEPATH(SNIP, RM_DNA2, PATH))
  }
  CHECK(kinship(SNIPS1,SNIPS2) < Degree);
  CHECK(verifysig(RM_DNA1,Signature,SigKey));
  CHECK(FamKey ==(G\hat{ }PrivKey));
}
```

As illustrated in this example, the computation that is proven correct by the cryptographic proof may, instead of taking as input the full first and second genomic sequences, take as input the hash tree roots 310 of hash trees 300 of the respective genomic data, as well as the variations (e.g., SNIPs) needed to perform the kinship computation. For each variation, the computation may take as input (e.g. comprised in the witness) a path (e.g., PATH) from the variation to the hash tree root (e.g., RM_DNA, RM_DNA2). To prove that the variation is comprised in the hash tree, a hash tree authentication algorithm e.g., as known from US patent application U.S. Pat. No. 4,309,569 may be applied to a variation (e.g., SNIP), its path, and the hash tree root. For a variation, this computation may scale only logarithmically in the size of the hash tree.

Although not shown in the above pseudocode, the computation may also prove that all variations of the first genomic data and/or all variations of the second genomic data are mutually distinct, in order to avoid that the authenticator always uses several copes of the same variation in the computation. For example, this check may be included in the kinship function.

The inventors realized that, by comparing only a subset of variations in the kinship function, there may be a risk that a malicious authenticator attempts to prove fake kinship by choosing only specific variations that lead the kinship function to establish that the given degree of kinship is present. To address this problem, the authenticator may be required to prove that a compared variation is comprised in a given set of variations suitable for kinship inference. For example, the given set of variations may be input by the verifier, or hard-coded into the key material for producing the proof. For example, the given set of variations may be defined by one or more intervals for the positions of the variations, by a hash tree of allowed position, etc. This is illustrated in the following pseudocode:

```
snark f( // see previous pseudocode examples
  public:[ RM_DNA2, VALID_RANGE, SigKey, FamKey , Degree],
  private:[ RM_DNA1, SNIPS1, PATHS1, SNIPS2 , PATHS2,
  Signature, PrivKey])
{
  for ((SNIP, PATH): (SNIPS1, PATHS1)) {
    CHECK(ISELEMENT(VALID_RANGE , SNIP)) // check against
    given set of variations
    CHECK(MERKLEPATH(SNIP, RM_DNA1, PATH)) ;
  }
  for ((SNIP, PATH): (SNIPS2, PATHS2)) {
    CHECK(ISELEMENT(VALID_RANGE , SNIP)) // check against
    given set of variations
    CHECK(MERKLEPATH(SNIP, RM_DNA2 , PATH));
  }
  CHECK(kinship(SNIPS1,SNIPS2) < Degree);
  CHECK(verifysig(RM_DNA1 ,Signature, SigKey));
  CHECK(FamKey == G\hat{ }PrivKey));
}
```

FIG. 4 schematically shows an example of an embodiment of a cryptographic verification device 411 for verifying an authentication of a public key. The cryptographic verification device may be based on cryptographic verification device 211 of FIG. 2b. As in FIG. 2b, functional units are shown in this figure as well as various elements that may be stored by the device 411 at various stages of its operation.

As also described with respect to FIG. 3, cryptographic verification device 411 may verify a cryptographic proof 077 that proves, among other things, that first genomic data (not shown) and second genomic data 081 have a given degree of kinship. The first and second genomic data may both comprise one or more variations indicating deviations from a reference genome, and the kinship function may compare respective corresponding variations. Various options of FIG. 3, e.g., for representing the first and/or second genomic data in a hash tree, also apply here.

Similarly to what was described for FIG. 3, also in this figure a kinship function is used that computes the degree of kinship based on only a subset of the variations comprised in the first and/or second genomic data. In this figure, however, to address the risk of a malicious authenticator proving fake kinship, use is made of further genomic data 082. In this example, cryptographic verification device 411 comprises a deviation generating unit 446 arranged to determine the further genomic data 082 by introducing deviations to the second genomic data 081 according to a statistical model of deviation likelihoods.

Cryptographic verification device 411 may comprise a proof verifying unit 444, e.g., based on proof verifying unit 244 of FIG. 2b, that verifies a cryptographic proof 077. Interestingly, this proof 077 may prove not just that the first genomic data and the second genomic data 081 have a first given degree of kinship, but also that the first genomic data and the further genomic data 082 do not have a second given degree of kinship.

Specifically, this way, an authenticator may be thwarted that attempts to prove kinship by targeting variations that are less unique. The further genomic data 082 includes statistical deviation of the original genomic data 081 according to a certain deviation factor. The computation proven correct in cryptographic proof 077 may now check that the first genomic data show kinship with the original genomic data 081 and not the deviation 082. Accordingly, the authenticator may be forced to inputting variations that are truly relevant to the kinship computation.

Cryptographic proving devices as described herein may be adapted to generate such a proof, e.g., to prove that first genomic data does not have a given degree of kinship with further genomic data. It is not necessary for the cryptographic verification device to generate the further genomic data 082; it can also obtain generated further genomic data 082 from elsewhere. Similarly to the second genomic data 081, also a representation of the further genomic data may be input to the verification of the cryptographic proof by the proof verifying unit 444, for example, a root of a hash tree or one of the other options discussed with respect to FIG. 2b.

As an illustration, the following pseudocode may be used:

```
snark f( // see previous pseudocode examples
  public: [RM_DNA2, RM_DNA_DEV, SigKey, FamKey, Degree, X // X: deviation factor
  private: [RM_DNA1, SNIPS1, PATHS1, SNIPS2, PATHS2,
SNIPS_DEV, PATHS_DEV, Signature, PrivKey])
{
  for ((SNIP, PATH, SNIP_D, PATH_D): (SNIPS2, PATHS2, SNIPS_DEV, PATHS_DEV)) {
    CHECK(MERKLEPATH(SNIP, RM_DNA2, PATH));
    CHECK(MERKLEPATH(SNIP_D, RM_DNA_DEV, PATH_D));
    CHECK(SAMEPOS(SNIP, SNIP_D)); // check that further genome is variation
  }
  for ((SNIP, PATH): (SNIPS1, PATHS1)) {
    CHECK(MERKLEPATH( SNIP, RM_DNA1 , PATH) );
  }
  CHECK(kinship(SNIPS1, SNIPS2 ) < Degree ); // check kinship wrt. second genome
  CHECK(kinship(SNIPS1, SNIPS_DEV) > (X*Degree)); // checkno kinship wrt. further genome
  CHECK(verifysig(RM_DNA1, Signature , SigKey ));
  CHECK(FamKey == (G\hat{ }PrivKey));
```

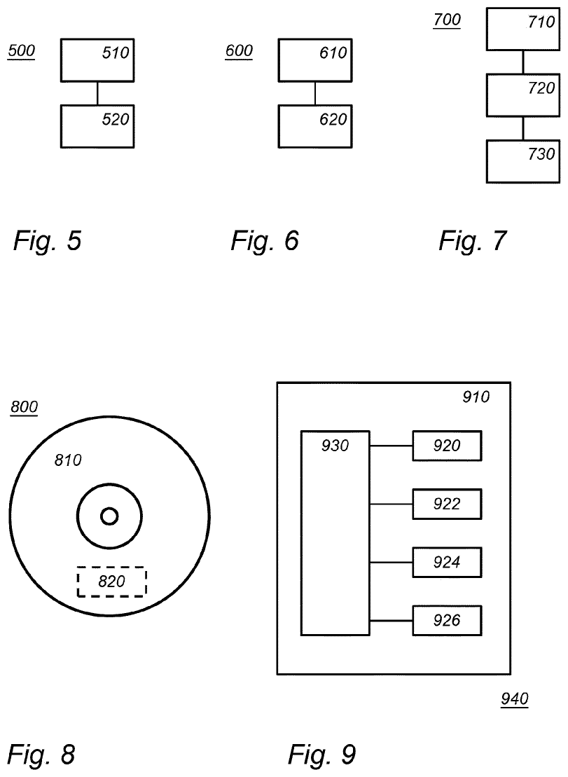

FIG. 5 schematically shows an example of an embodiment of a computer-implemented cryptographic authentication method 500 of authenticating a public key. This authenticating may be for proving that the public key belongs to a first person with a given degree of kinship to a second person.

Method 500 may comprise storing 510: first genomic data representing a genomic sequence of the first person and/or a digital signature on the first genomic data, verifiable with respect to a verification key and/or second genomic data representing a genomic sequence of the second person.

Method 500 may comprise generating 520 a cryptographic proof. The cryptographic proof may be verifiable with respect to at least the public key. The cryptographic proof may prove that the public key belongs to a person with the given degree of kinship to the second person. To this end, the proof may prove that the first genomic data and the second genomic data have the given degree of kinship, as computed by a kinship function on the first and second genomic data. To the same end, the proof may further prove that the digital signature verifies successfully with respect to the first genomic data and the verification key.

FIG. 6 schematically shows an example of an embodiment of a computer-implemented cryptographic key generation method 600 of generating key material for authenticating a public key. This authentication may be for proving that the public key belongs to a first person with a given degree of kinship to a second person.

Method 600 may comprise storing 610: the generated key material. The key material may comprise a computation evaluation key for generating a cryptographic proof and computation verification key for verifying the cryptographic proof.

Method 600 may comprise generating 620 the key material for the cryptographic proof. The cryptographic proof may be verifiable with respect to at least the public key. The cryptographic proof may prove that the public key belongs to a person with the given degree of kinship to the second person. To this end, the proof may prove that first genomic data representing a genomic sequence of the first person and second genomic data representing a genomic sequence of the second person have the given degree of kinship, as computed by a kinship function on the first and second genomic data. To the same end, the proof may prove that a digital signature on the first genomic data verifies successfully with respect to the first genomic data and the verification key.

FIG. 7 schematically shows an example of an embodiment of a computer-implemented cryptographic verification method 700 of verifying an authentication of a public key. This authentication may be for proving that the public key belongs to a first person with a given degree of kinship to a second person.

Method 700 may comprise storing 710: the public key to be authenticated.

Method 700 may comprise obtaining 720 and verifying 730 a cryptographic proof. The cryptographic proof may be verifiable with respect to at least the public key. The cryptographic proof may prove that the public key belongs to a person with the given degree of kinship to the second person. To this end, the cryptographic proof may prove that first genomic data representing a genomic sequence of the first person has a given degree of kinship with second genomic data representing a genomic sequence of the second person, as computed by a kinship function on the first and second genomic data. To the same end, the cryptographic proof may further prove that digital signature on the first genomic data verifies successfully with respect to the first genomic data and a verification key.

Many different ways of executing the methods are possible, as will be apparent to a person skilled in the art. For example, the order of the steps of method 500, 600, and/or 700 can be varied or some steps may be executed in parallel. Moreover, in between steps other method steps may be inserted. The inserted steps may represent refinements of the method such as described herein, or may be unrelated to the method. For example, steps 510 and 520 of method 500 may be executed, at least partially, in parallel. Moreover, a given step may not have finished completely before a next step is started. The methods may be combined, e.g., key generation method 600 may be followed by verification method 700 using the generated key material.

Embodiments of the methods may be executed using software, which comprises instructions for causing a processor system to perform a method 500, 600, or 700. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. Embodiments of the method may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source, and object code such as partially compiled form, or in any other form suitable for use in the implementation of an embodiment of the method. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

FIG. 8 shows a computer readable medium 800 having a writable part 810. Writable part 810 may comprise a computer program 820 comprising instructions for causing a processor system to perform one or more methods as described herein; a cryptographic proof generated according to a described method; and/or key material for a cryptographic proof generated according to a described method. The computer program 820 may be embodied on the computer readable medium 800 as physical marks or by means of magnetization of the computer readable medium 800. However, any other suitable embodiment is conceivable as well. Furthermore, it will be appreciated that, although the computer readable medium 800 is shown here as an optical disc, the computer readable medium 800 may be any suitable computer readable medium, such as a hard disk, solid state memory, flash memory, etc., and may be non-recordable or recordable.

FIG. 9 shows in a schematic representation of a processor system 940 according to an embodiment. The processor system comprises one or more integrated circuits 910. The architecture of the one or more integrated circuits 910 is schematically shown in FIG. 7b. Circuit 910 comprises a processing unit 920, e.g., a CPU, for running computer program components to execute a method according to an embodiment and/or implement its modules or units. Circuit 910 comprises a memory 922 for storing programming code, data, etc. Part of memory 922 may be read-only. Circuit 910 may comprise a communication element 926, e.g., an antenna, connectors or both, and the like. Circuit 910 may comprise a dedicated integrated circuit 924 for performing part or all of the processing defined in the method. Processor 920, memory 922, dedicated IC 924 and communication element 926 may be connected to each other via an interconnect 930, say a bus. The processor system 910 may be arranged for contact and/or contact-less communication, using an antenna and/or connectors, respectively.

For example, in an embodiment, processor system 940, e.g., the cryptographic authentication device, the cryptographic verification device, or the cryptographic key generation device, may comprise a processor circuit and a memory circuit, the processor being arranged to execute software stored in the memory circuit. For example, the processor circuit may be an Intel Core i7 processor, ARM Cortex-R8, etc. In an embodiment, the processor circuit may be ARM Cortex M0. The memory circuit may be an ROM circuit, or a non-volatile memory, e.g., a flash memory. The memory circuit may be a volatile memory, e.g., an SRAM memory. In the latter case, the device may comprise a non-volatile software interface, e.g., a hard drive, a network interface, etc., arranged for providing the software.

Typically, the devices each comprise a microprocessor which executes appropriate software stored at the devices; for example, that software may have been downloaded and/or stored in a corresponding memory, e.g., a volatile memory such as RAM or a non-volatile memory such as Flash. Alternatively, the devices may, in whole or in part, be implemented in programmable logic, e.g., as field-programmable gate array (FPGA). The devices may be implemented, in whole or in part, as a so-called application-specific integrated circuit (ASIC), e.g., an integrated circuit (IC) customized for their particular use. For example, the circuits may be implemented in CMOS, e.g., using a hardware description language such as Verilog, VHDL etc.

In an embodiment, the cryptographic authentication device comprises a key generation circuit, a signing circuit, and a proving circuit. In an embodiment, the cryptographic verification device comprises a proof verifying circuit and a signature verifying circuit. The devices may comprise additional circuits, e.g., a deviation generating circuit. The circuits implement the corresponding units described herein. The circuits may be a processor circuit and storage circuit, the processor circuit executing instructions represented electronically in the storage circuits. A processor circuit may be implemented in a distributed fashion, e.g., as multiple sub-processor circuits. Part of the storage may be read-only. The circuits may also be, FPGA, ASIC or the like. A storage may be distributed over multiple distributed sub-storages. Part or all of the memory may be an electronic memory, magnetic memory, etc. For example, the storage may have volatile and a non-volatile part.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb ‘comprise’ and its conjugations does not exclude the presence of elements or steps other than those stated in a claim. The article ‘a’ or ‘an’ preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. Measures recited in mutually different dependent claims can be advantageously combined.

In the claims references in parentheses refer to reference signs in drawings of exemplifying embodiments or to formulas of embodiments, thus increasing the intelligibility of the claim. These references shall not be construed as limiting the claim.

1. A cryptographic authentication device, the device comprising:
a memory arranged for storing:
first genomic data representing a genomic sequence of the first person;
a digital signature on the first genomic data, verifiable with respect to a verification key; and
second genomic data representing a genomic sequence of the second person;
a processor arranged to generate a cryptographic proof, the cryptographic proof being verifiable with respect to at least a public key, the cryptographic proof proving that the public key corresponds to a person with a degree of kinship to the second person by proving that:
the first genomic data and the second genomic data have the degree of kinship, as computed by a kinship function on the first and second genomic data; and
the digital signature verifies successfully with respect to the first genomic data and a verification key.

2. The device of claim 1, wherein the first and second genomic data both comprise one or more variations indicating respective genomic sequences deviate from a reference genome, the processor being arranged to compute the kinship function by comparing a respective corresponding variations comprised in the first and second genomic data.

3. The device of claim 2, wherein the one or more variations comprised in the first genomic data are represented in a hash tree, the processor being arranged to prove that a variation of the one or more variations is comprised in the hash tree.

4. The device of claim 2, the processor being arranged to compare only a subset of the variations comprised in the first genomic data to corresponding variations comprised in the second genomic data, the processor being further arranged to prove that a compared variation is comprised in a given set of variations suitable for kinship inference.

5. The device of claim 2, the processor being arranged to compare only a subset of the variations comprised in the first genomic data to corresponding variations comprised in the second genomic data, the processor being further arranged to compare said subset of variations to corresponding variations comprised in further genomic data to prove that the first genomic data does not have a given degree of kinship with the further genomic data, the further genomic data being generated from the second genomic data by introducing deviations to the second genomic data according to a statistical model of deviation likelihoods.

6. The device of claim 1, wherein the processor is further arranged to obtain a document and generate a digital signature on the document, verifiable using the public key.

7. The device of claim 1, wherein the cryptographic proof is a zero-knowledge non-interactive argument of knowledge.

8. The device of claim 1, wherein the processor is arranged to prove that the digital signature successfully verifies with respect to a verification key from a set of multiple verification keys.

9. A computer-implemented cryptographic authentication method of authenticating a public key, said authenticating being for proving that the public key corresponds to a first person with a degree of kinship to a second person, the method comprising:
storing: first genomic data representing a genomic sequence of the first person; a digital signature on the first genomic data, verifiable with respect to a verification key; and second genomic data representing a genomic sequence of the second person;
generating a cryptographic proof, the cryptographic proof being verifiable with respect to at least the public key, the cryptographic proof proving that the public key corresponds to a person with the degree of kinship to the second person by proving that:
the first genomic data and the second genomic data have the given degree of kinship, as computed by a kinship function on the first and second genomic data; and
the digital signature verifies successfully with respect to the first genomic data and the verification key.

10. A cryptographic key generation device for generating key material for authenticating a public key, said authentication being for proving that the public key corresponds to a first person with a degree of kinship to a second person, the device comprising:
a memory arranged for storing: the generated key material, the key material comprising a computation evaluation key for generating a cryptographic proof and computation verification key for verifying the cryptographic proof;
a processor arranged to generate the key material for the cryptographic proof, the cryptographic proof being verifiable with respect to at least the public key, the cryptographic proof proving that the public key corresponds to a person with the degree of kinship to the second person by proving that:
first genomic data representing a genomic sequence of the first person and second genomic data representing a genomic sequence of the second person have the degree of kinship, as computed by a kinship function on the first and second genomic data; and
a digital signature on the first genomic data verifies successfully with respect to the first genomic data and the verification key.

11. A computer-implemented cryptographic key generation method, the method comprising:
generating a key material for a cryptographic proof, the cryptographic proof being verifiable with respect to at least a public key, the cryptographic proof proving that the public key corresponds to a person with a degree of kinship to the second person by proving that:
first genomic data representing a genomic sequence of the first person and second genomic data representing a genomic sequence of the second person have the given degree of kinship, as computed by a kinship function on the first and second genomic data; and
a digital signature on the first genomic data verifies successfully with respect to the first genomic data and the verification key.

12. A cryptographic verification device, the device comprising:
a memory arranged for storing: an authenticatable public key;
a processor arranged to obtain and verify a cryptographic proof, the cryptographic proof being verifiable with respect to at least the public key, the cryptographic proof proving that the public key corresponds to a person with a degree of kinship to the second person by proving that:
first genomic data representing a genomic sequence of the first person has the degree of kinship with second genomic data representing a genomic sequence of the second person, as computed by a kinship function on the first and second genomic data; and
a digital signature on the first genomic data verifies successfully with respect to the first genomic data and a verification key.

13. A computer-implemented cryptographic verification method, the method comprising:
obtaining and verifying a cryptographic proof, the cryptographic proof being verifiable with respect to at least a public key, the cryptographic proof proving that the public key corresponds to a person with a degree of kinship to the second person by proving that:
first genomic data representing a genomic sequence of the first person has the degree of kinship with second genomic data representing a genomic sequence of the second person, as computed by a kinship function on the first and second genomic data; and
a digital signature on the first genomic data verifies successfully with respect to the first genomic data and a verification key.

14. A cryptographic authentication system comprising at least:
a cryptographic authentication device and
a cryptographic verification device according to claim 12.

15. A non-transitory computer readable storage medium comprising:
a cryptographic proof generated according the method of claim 11;
key material for a cryptographic proof.

16. The computer readable storage medium storing a key material for a cryptographic proof, wherein the key material is generated according to the method of claim 13.

17. The computer-implemented cryptographic verification method of claim 13, further comprising:
storing key material, the key material comprising a computation evaluation key for generating the cryptographic proof and computation verification key for verifying the cryptographic proof.

18. The cryptographic authentication device of claim 1, wherein the public key corresponds to a first person with respect to the first person's genomic data.
